(19) United States
(12) Patent Application Publication
(10) Pub. No.: US 2013/0063583 A1
(43) Pub. Date: Mar. 14, 2013

(54) SYSTEM AND METHOD FOR DIGITIZING A MOVING SLIDE

(71) Applicants: Béla Molnár, Budapest (HU); Tibor Virág, Budapest (HU); Viktor Sebestyén Varga, Budapest (HU)

(72) Inventors: Béla Molnár, Budapest (HU); Tibor Virág, Budapest (HU); Viktor Sebestyén Varga, Budapest (HU)

(21) Appl. No.: 13/512,265

(22) PCT Filed: Nov. 29, 2010
(86) PCT No.: PCT/HU10/00130

§ 371 Date: Nov. 28, 2012

Related U.S. Application Data
(60) Provisional application No. 61/264,732, filed on Nov. 27, 2009.

(30) Foreign Application Priority Data
Nov. 27, 2009 (HU) P0900741

(51) Int. Cl. H04N 7/18

(52) U.S. Cl. 348/79; 348/E05.024

(57) ABSTRACT

The present invention relates to a system and a method of digitizing a moving slide (4). According to the invention, the slide (4) is displaced via stepper motors (6X, 6Y, 6Z) and the exposition of said slide (4) for imaging purposes is performed in synchronous with pre-set numbers of steppings (nx, ny, nz) accomplished by said stepper motors (6X, 6Y, 6Z) by activating a light source (2) that is capable of emitting a luminous flux high enough. Said light source (2) is preferably controlled directly by the stepper motors (6X, 6Y, 6Z).

The present invention relates to the digitization of a moving slide, especially with a sample (of e.g. biological origin), by means of a high intensity light source.

The analysis of various samples of biological origin, in particular tissue sections, smears, etc., is an important field of medical diagnostics. To perform such an analysis, for example a tissue specimen taken from a patient is sliced up in very fine (e.g. 2 to 5 μm thick) sections, which are then placed on slides and stained with various dyes. Similarly, smear samples are also arranged on glass plates and stained with various dyestuffs. After completion of staining, the specimen on the slide is first covered with a coating substance and then with a cover plate. Finally, the thus prepared specimen-bearing slide is directly subjected to a microscopical analysis or digitized (as is discussed e.g. in U.S. Pat. No. 6,246,785 B1 and International Patent Application No. PCT/HU2007/000018) and then the thus obtained, so-called digital (virtual) slide is studied. The advantage of making use of virtual slides is provided by the disappearance of spatial and temporal limits regarding the completion of an actual analysis, the ease with archiving, the possibility of remote access, as well as e.g. the capabilities of teleconsultation. Digitization of slides produced in great amounts in clinical practice is preferentially performed in an automated way, by means of a particular digitizing apparatus designed distinctively for this purpose.

In nowadays common practice, when slides are digitized automatically, each slide to be digitized passes in front of preferably one or more objectives with preferentially different resolutions of one or more optical imaging systems of a given resolution and magnification. The digitization of slides is performed from region to region, wherein each region has dimensions corresponding practically to those of the given field of view of the imaging system limited by the resolution required. The images of said regions overlap to each other, thus to create the virtual slide, a stitching of the images of the individual regions along with an appropriate (e.g. software) matching is required. To record digital images of the regions, the slide has to occupy a stationary position in front of the objective in order to avoid blurring. To this end, the slide has to be stopped for a given amount of time by the slide displacing mechanism, and then, after the capturing has taken place (that is, after completing digitization of the region concerned) said slide has to be put in motion again for a progress and to have the next slide region to be captured moved into the field of view of the objective. When it is performed in an automated manner and continuously, the digitization of a single slide requires, hence, a significant amount of time, since for imaging each field-of-view sized region of the slide, first the slide displacing mechanism has to speed the slide up (to advance the next region into the filed of view of the detector) and then it has to slow said slide down (to accomplish stopping/positioning required by the image recording). A portion of a conventional slide to be digitized (containing the samples that are interesting to the user) can be divided into such elementary regions that have dimensions equal to those of the field of view, are contiguous and do not overlap to one another, wherein the height/width of a field of view used for digitizing is about 200 μm in general. The slide displacing mechanism reaches its maximum speed within a time period needed to run a distance of about 250 to 300 μm. As for image capturing it has to stop in a time period needed to run a distance of about 200 μm (which corresponds to an advancement of about a single side of view), the maximum speed that could be reached by said slide displacing mechanism will not be practiced at all.

A further problem that a repeated start and stop of the slide displacing mechanism is accompanied by mechanical vibrations. This might result in distorted and/or blurred images, due to which a repetition of digitization might be needed for a part of the slides. To this end, the slides involved must be picked out/collected which requires an intervention of a human operator. Moreover, in general, in such cases the repeated digitization will be performed manually that also requires an active contribution from the operator. The repeated digitization of slides, that might be necessary, greatly delays the assessment of the samples of biological origin carried by the slides concerned and ultimately also the making of proper diagnosis itself. Furthermore, in certain cases (e.g. in case of samples stained with fluorescent dyes), due to an occurrent sample exhaust/spoilage there is simply no way to repeat the digitization.

The start, then the speed-up and the subsequent slow-down and finally the stop exert quite a high load on the mechanical components of the slide displacing mechanism. As a consequence, a premature wear of said parts can occur that might result in the requisite of an early maintenance of the digitizing apparatus or even its premature breakdown. A disadvantage of the huge current drain that also accompanies the high load (compared to the relatively even and small current drains at constant speeds) and, hence, increases the operation costs of such an automated digitizing apparatus, as well as the costs of producing the virtual slides, cannot be neglected either.

U.S. Pat. No. 6,798,571 B2 (Wetzel et al.) discloses an automated digitizing apparatus for continuously digitizing a given (sample carrying) portion of a slide on a field of view basis, wherein said slide is moving all the time during digitization. Capturing of images with proper contrast is ensured by a strobe illumination of the moving slide. To generate the virtual slide, the digital image segments captured on a field of view basis have to be stitched together into a single so-called montage image. To provide a fast and efficient stitching process, the individual image segments have to match precisely with one another along their edges, that is, they should potentially be non-overlapping, and in turn they have to cover the slide completely. According to said U.S. patent, an attempt is made at achieving this by continuously sensing the actual position of the slide relative to the field of view of the objective of the imaging system during continuous advancement of the slide by means of an additional external position detector and triggering the strobe illumination for the capture of a digital image (that is to capture an image of the next portion of said slide) in that moment when the slide occupies a position in which the image of a field-of-view sized portion of said slide being just digitized does not potentially overlap to the images of the previously imaged field-of-view sized portions of said slide at all or an overlap to a small extent arises only. In this way, the individual image segments will essentially be non-overlapping or match completely with one another. To this end, a properly timed actuation of the strobe illumination is realized in a timed manner by means of an electrical signal of the additional external position detector.

For an accurate triggering of the strobe illumination there is a need, on the one hand, for a reliably accurate and fast position detector, and on the other hand, for a continuous monitoring and evaluation of the signal of said position detector. However, the application of a position detector increases the risk of malfunction and the production costs of the digitizing apparatus as a whole. Furthermore, the application of a position detector makes the digitizing process more complicated, since in the form of the signal generated by said position detector, a further control signal must also be taken into account when said process is to be performed. Moreover, to avoid erroneous digitization, functioning of the position detector has to be continuously monitored in order to screen out its potential malfunction and inaccuracy.

The object of the present invention is to eliminate the above deficiencies, in particular, to provide a method, as well as a system that can be used as an automated digitizing apparatus for digitizing a moving slide that allow digitization of the slide without using an additional external position detector that monitors the actual position of the slide along with the least possible overlap at the edges of the image segments captured consecutively on a field-of-view basis and generating image segments of a proper contrast.

Furthermore, the present invention in particular aims at providing such solutions that are suitable for digitizing a slide with a sample (of e.g. biological origin) in a simple manner, as well as accurately, rapidly and reliably at high resolutions along with operating the slide displacing mechanism with a mean speed as high as possible and thus significantly decreasing the amount of time required for the digitization of a slide. A further object of the present invention is to attain and practice the maximum slide displacement speed achievable by the slide displacing mechanism so as to decrease the above discussed wear of the mechanical components. In this way, the risk of premature deterioration of the slide displacing mechanism can be diminished and the durability/lifetime of the automated digitizing apparatus can simultaneously be increased. A yet further object of the invention is to eliminate (or at least to attenuate) mechanical vibrations due to the repeating starts and stops of the slide and, hence, to improve the quality of digitally recorded image segments, as well as of the virtual slide obtained as a montage image through the stitching of said image segments.

The above objects are achieved by a system in accordance with claim 1 that provides an automated digitizing apparatus. Said system comprises at least a light source of high intensity, as well as at least an optical detector with a pre-set sized field of view as a component of an optical imaging system. The light source and the detector are fixed as to location and position/alignment, and the light sensing surface of said detector faces to the light source. Said light source and said detector are preferably arranged along a common optical axis. Said optical detector is preferably formed by a camera (of e.g. a CCD type) of a given resolution and is in data communication connection with a means for storing signals detected by said light sensing surface (i.e. with a memory, hard disk, etc.). A per se known slide holder is arranged between the light source and the detector. Said slide holder is designed for receiving a sample carrying slide to be digitized at least partially. The illumination required for the capture of an image (i.e. digitizing) of the sample located on the slide with a prescribed contrast (that preferentially allows a subsequent assessment of the image) is provided by said high intensity light source.

To digitize the slide region by region in a continuous manner, a displacement thereof is required. The displacement of said slide comprises on the one hand a displacement along the optical axis (that is, for focusing purposes) and on the other hand a displacement within a plane perpendicular to said optical axis for generating separate segments of the montage image. Said displacements are accomplished by means of a per se known slide displacing mechanism comprising stepper motors performing displacements along said optical axis (from now on Z-direction) and displacements along directions at right angles to one another (from now on X- and Y-directions) within said plane (from now on XY-plane) perpendicular to the optical axis, and transmissions converting driving of the stepper motors into displacements of the slide holder (and thus of the slide itself) along the respective directions. The system also includes a central control and processing unit, preferably in the form of a computer, that makes said system to operate; said control and processing unit controls the start/stop of said stepper motors, and optionally is involved in the assessment, processing and further handling of the signals arriving from the optical detector, too.

It is well known that a stepper motor rotates into a desired position upon a control signal, maintains the position occupied after the control signal has ceased, the stepping errors arising when changes in the position via stepping take place do not add up, and the precision of positioning is about 1-5% in general. An essential further characteristic of stepper motors is the total number of steps required for a full revolution (from now on, the nominal stepping number).

The burden of the present invention lies in that dimensions of the field of view along the X- and Y-directions to be used for carrying out the digitization correspond to displacements of the slide along respective in-plane (X- and Y-) directions accomplished by the stepper motors responsible for the in-plane displacement of said slide in a set number of steppings (n_{X} and n_{Y}, respectively) in each direction, and the trigger signal for activating the light source is generated and transmitted to said light source in synchronous with reaching at least one of the pre-set stepping numbers (n_{X} or n_{Y}) by the stepper motors effecting in-plane slide displacements and cyclically as per said stepping numbers. That is, the dimensions of the field of view, to be used for and set before the digitization as desired, along the X- and Y-directions are chosen in such a way that—taking the transmissions provided by the stepper motors also into account—any two adjacent field-of-view sized slide regions would fall into a precise covering alignment with one another after the pre-set number of steppings n_{X} or n_{Y} has been performed by the respective one of the stepper motors for in-plane displacement (here the positional error is also neglected). Said trigger signal for activating the light source is preferably generated and transmitted to said light source directly by the stepper motors performing in-plane displacements via a suitable communication link. Preferably, said pre-set stepping numbers n_{X}, n_{Y} correspond to the nominal stepping numbers of the stepper motors for in-plane displacement of the slide along the respective directions.

Putting this another way, the stepper motors providing continuous displacement of the slide, required for its digitization, along a certain direction through a series of consecutive steppings shift the slide along one of the X- and Y-directions right by a field-of-view sized region per n_{X} or n_{Y} number of steppings and always activate simultaneously the light source as well. Consequently, during the continuous movement of the slide, an illumination thereof fully synchronized with the field-of-view sized shift of said slide is provided via the direct triggering of said light source that takes place per field-of-view sized shifts of the slide, without applying any further additional external position detectors, and based purely on monitoring the number of steppings performed by said stepper motors. In such a combined shift/illumination, digital image segments of field-of-view sized regions of the slide adjoined to one another will be captured in consequent steps. Due to such synchronization of the stepping and illumination, the image segments concerned will overlap along their edges to an extent that depends on the precision of positioning of the stepper motors. Furthermore, a complete imaging of the whole slide surface is assured. There is no need for an external position detector which detects continuously the instant position of the slide relative to the optical detector; the matching of image segments (with a slight overlap) corresponding to consecutive slide regions is provided by the precisions of the positioning and the position maintenance of the stepper motors for in-plane displacement. When composing the montage image, small overlaps of separate image segments can be eliminated in a simple and rapid manner by any suitable means (e.g. software matching/stitching), as it is known by the skilled person in the art.

When digitizing a slide, adequately sharp images of consecutive slide regions should be captured. To provide appropriate focussing, said slide has to be subjected to a displacement along the Z-direction as well, besides its displacement within the XY-plane. As part of the inventive solution, for focussing purposes the displacement of the slide along the Z-direction is performed in a continuous manner (simultaneously with the stepping along the X- and/or Y-directions) and also with constant speed by a stepper motor responsible for Z-direction steppings. In the meantime, said light source is operated in synchronous with the Z-direction stepping, that is, per n_{Z} number of steppings set for the Z-direction stepper motor (here, n_{Z} is preferably much smaller than any of n_{X} and n_{Y}) and thereby several consecutive images are captured in various focal planes. In this case, a trigger signal that activates the light source is generated and transmitted to said light source via a suitable communication link by the Z-direction stepper motor. The image of best quality that belongs to the just digitized field-of-view sized slide region is chosen from the thus obtained images by means of the technique of interpolated focussing known by the skilled person in the art. (For the details of interpolated focussing, the reader is kindly referred to published U.S. Patent Appl. No. 2009/231689 A1.) By applying the above discussed synchronization, the disadvantages due to cyclical changes in slide speed that arise when focussing is performed are also eliminated which results in a yet faster digitization of the slide. It was found that, compared to a digitization of a slide performed traditionally, the same slide could be digitized by the present solution about three to five times faster, without a loss of quality in either the individual image segments or, ultimately, the montage-image itself. It should be here noted that the position of the slide relative to the optical detector has to be determined and stored only at the start of digitization when the first field of view is precisely selected; knowing perpendicular dimensions of said field of view and the nominal stepping numbers of the stepper motors for in-plane displacement, said position can be determined later at any time from the total number of steppings effected by each stepper motor alone.

A further advantage of the present inventive solution is that a slide is digitized in its continuous motion, due to which the slide displacement speed remains constant during digitization, and thus the load on the slide displacing mechanism due to the cyclical changes in said speed is also eliminated.

In a possible further embodiment of the system according to the invention said light source of high intensity is operated by the central control and processing unit, provided preferably by a computer. In this case, the electric trigger signal transmitted to either the X-direction or the Y-direction stepper motor in order that it be commanded to perform every respective n_{X}-th or n_{Y}-th step, or to the Z-direction stepper motor in order that it be commanded to perform every n_{Z}-th step, also induces, simultaneously with starting said step, the light source to emit intense light during the exposition period. It should be here noted that synchronized operation of the light source to perform exposition can be attained by any of the central control and processing unit and said stepper motors.

In a possible yet further embodiment, said light source is provided in the form of a high intensity light source capable of emitting variable luminous flux. When the system for digitizing according to the invention is in operation, said light source continuously emits a first luminous flux, then to image a field-of-view sized slide region to be digitized, upon a trigger signal of any of the stepper motors or the central control and processing unit, it will emit a second luminous flux for a pre-set period of about 1 μs of the exposition, wherein said second luminous flux is significantly higher than the first one. In particular, said second luminous flux is preferably at least five times, more preferably at least ten times and even more preferably at least hundred times higher than said first luminous flux. Preferably, said second luminous flux is at least about 40 mJ per exposition. Preferably, the light source capable of emitting variable luminous flux is provided by the combination of at least a light source capable of providing continuous illumination with low luminous flux and at least a further light source emitting for a short period of time (exposition) with high luminous flux; this latter light source is provided preferably by a flash lamp.

The present invention also provides a method of digitizing a moving, sample-carrying slide, in accordance with claim 9, wherein individual image segments of a montage image of the slide area to be digitized are captured by operating a high intensity light source that is triggered periodically as a function of current stepping numbers of stepper motors for the continuous in-plane displacement of the slide.

In what follows, the invention is discussed in more detail in relation with its preferred embodiments with reference to the attached drawing, wherein

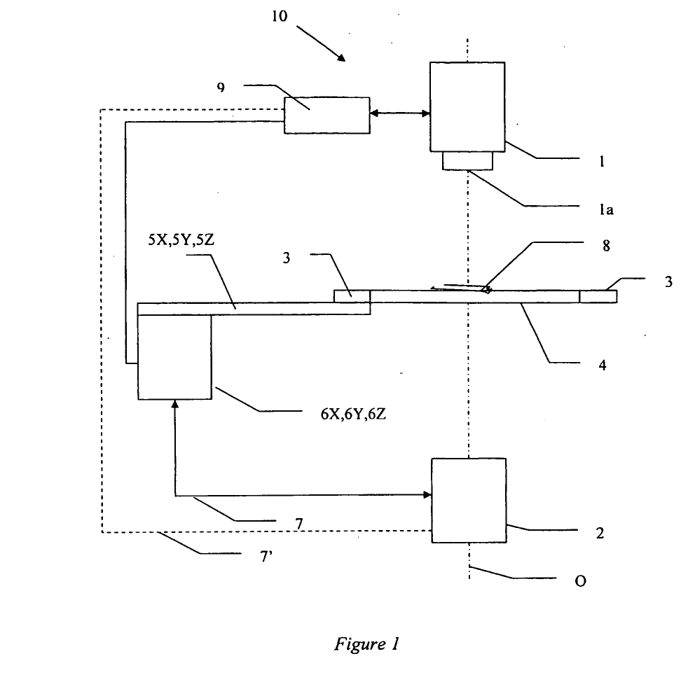

FIG. 1 illustrates schematically, in side elevation, a possible embodiment of the system to be used as an automated digitizing apparatus according to the invention; and

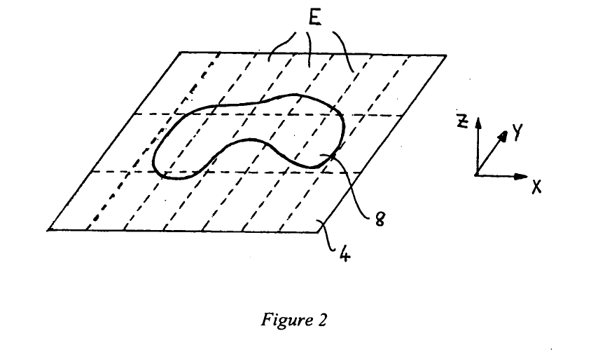

FIG. 2 shows a perspective view of a planar slide, wherein an imaginary partition (not to scale) of the slide surface (illustrated by dashed lines) into regions corresponding to the field of view of the optical detector used in the imaging system can also be seen; during digitization of a slide, the stepper motors performing the in-plane displacement of the slide always shift said slide by a single filed of view at a time relative to the optical detector along the X- or Y-directions within the XY-plane; a displacement of said slide along the Z-direction for focussing purposes takes place along an axis perpendicular to the XY-plane shown.

An automated digitizing apparatus 10 corresponding to the system, illustrated schematically in FIG. 1, comprises an optical axis O (drawn by a dotted-dashed line in FIG. 1), an optical detector 1 with a sensing surface 1a arranged on the optical axis O and constituting part of an imaging system, a slide holder 3 being essentially perpendicular to the optical axis O and a light source 2. A slide 4 carrying sample(s) 8 is arranged/clamped in a per se known manner within said slide holder 3. Said sensing surface 1a lies in a plane that is essentially perpendicular to the optical axis O and faces towards the slide holder 3. In the embodiment shown in FIG. 1, the optical detector 1 and the light source 2 are fixed, as to digitize an extended portion of the slide 4, a displacement of said slide 4 is effected by displacing said slide holder 3. It is, however, apparent to skilled person in the art that further embodiments of the apparatus 10, wherein any of the optical detector 1 and the light source 2 is/are shiftable relative to a selected portion of the slide 4 in a plane being essentially perpendicular to the optical axis O, can easily be constructed, too. In this embodiment, said light source 2 is preferentially arranged on the optical axis O, on the side of said slide holder 3 that locates opposite to the optical detector 1, and faces towards said optical detector 1. That is, at least a portion of illuminating light emitted by said light source 2 (providing, hence, dark-field illumination) propagates towards the optical detector 1 after leaving said light source 2. Said automated digitizing apparatus 10 can also be constructed with a light source arrangement providing bright-field illumination. The slide holder 3 is provided by a slide holder well-known in the field of microscopy which, on the one hand, for focussing purposes is displaceable along the optical axis O (Z-direction) in a way known by a skilled person in the art, and, on the other hand, for an appropriate in-plane (XY) positioning of the slide 4 with the sample 8 arranged therein, said slide holder 3 can arbitrarily be displaced in the plane perpendicular to the optical axis O. Displacements of the slide holder 3 along the optical axis O and/or in a plane perpendicular to the latter can be accomplished by a per se known slide displacing mechanism, e.g. via screw spindles 5X, 5Y, 5Z by means of stepper motors 6X, 6Y, 6Z (further details can be found e.g. in EP-1,789,831 B1). The stepper motors 6X, 6Y, 6Z, through their electronics, are in a direct controlling connection via a communication link 7 with the light source 2. The actuation of said light source 2, and hence the exposition itself, is governed by the stepper motors 6X, 6Y, 6Z themselves in synchronous with the displacement of the slide holder 3, as well as the slide 4 arranged in therein, by sending out an appropriately timed control signal (a trigger signal), as will be discussed below. The communication link 7 can be provided by an arbitrary wired or wireless communication link. Said stepper motors 6X, 6Y, 6Z are also connected with a central control and processing unit 9: the displacements of said slide holder 3 within the XY-plane and along the Z-direction are performed by the control and processing unit 9 via appropriate control signals.

In the system illustrated in FIG. 1, the light scattered by the slide 4, as well as the sample 8 thereon, illuminated by the light source 2 strikes the sensing surface 1a of the optical detector 1, wherein it is converted into digital signals carrying information about the field-of-view sized region E of the slide 4 (see FIG. 2) being just digitized, i.e. its raw, unprocessed image. The output of said optical detector 1 is preferably in a data communication connection with the control and processing unit 9; for further processing/evaluation/handling, and optionally to be displayed or stitched into a montage image, the optical detector 1 transmits said digital signals to the control and processing unit 9. For storing images of the field-of-view sized regions E of the slide 4, the control and processing unit 9 is connected to a data storage means (not shown in the drawing). Preferentially, said control and processing unit 9 is a computer with a software for the proper control/processing/evaluation/stitching. Moreover, the control and processing unit 9 can also be provided e.g. by a microcontroller or any other suitable means.

In a possible further embodiment of the automated digitizing apparatus shown in FIG. 1, said light source 2 is also in data communication connection with the central control and processing unit 9 (as is marked by connection 7′ of FIG. 1 shown by a dashed line). In this embodiment, the control and processing unit 9 actuates said light source 2 via appropriate trigger signal(s) in synchronous with the actuation of stepper motors 6X, 6Y, 6Z for the continuous displacement of the slide 4 within the XY plane and simultaneously along the Z-direction.

A possible yet further embodiment of the automated digitizing apparatus shown in FIG. 1 differs from the embodiments discussed earlier in that in this case, when the automated digitizing apparatus 10 is in operation, the light source 2 operates continuously with emitting a first luminous flux, and then upon a trigger signal of the central control and processing unit 9 or one of the stepper motors 6X, 6Y, 6Z, it emits a second luminous flux that is much higher than said first one during a set period of the exposition that takes about 1 μs to image the field-of-view sized slide region concerned. Said second luminous flux is preferably at least five times, more preferably at least ten times and even more preferably at least hundred times higher than the first one. The second luminous flux is about 40 mJ per exposition. According to an advantage of this latter embodiment, due to the continuous operation of the light source 2 at the first luminous flux, the amount of light required when e.g. a search for the location of a sample 8 on said slide 4 takes place or to record a preview image essential for a proper initial positioning of the slide 4 is naturally provided.

It should be also noted that the embodiments shown here in detail are only to illustrate the inventive concept and should not be construed as limiting the present invention; further embodiments of the automated digitizing apparatus in accordance with the inventive system can also be constructed within the scope of protection defined by the attached claims.

In what follows the operation of an embodiment of the automated digitizing apparatus 10 in accordance with the inventive system shown in FIG. 1 is discussed.

After the apparatus 10 has been installed and energized, the slide 4 is arranged within the slide holder 3. To accelerate the digitization of the slide 4, optionally, a preview image is recorded over the sample-carrying surface of the slide 4 with the provision of an appropriate illumination—provided preferentially by the light source 2—by means of the technique of interpolated focussing, and then, making use of said preview image, the initial starting position of the digitization and/or the slide regions to be digitized are looked for in a way known per se.

After completing the optional positioning, in order to digitize said slide 4 with the sample 8 by an illumination of high luminous flux, the following steps are carried out.
A signal triggering an in-plane displacement is generated by the central control and processing unit 9 and transmitted then to the stepper motors 6X, 6Y, 6Z. As a response to this, the stepper motors 6X, 6Y for displacing within the XY-plane make the slide holder 3, as well as the slide 4 with the sample 8 arranged therein to move by means of the driven spindles 5X, 5Y, and depending on the information content of said signal they commence its field-of-view sized region by region stepping along one of the X- or Y-directions within a plane perpendicular to the optical axis O.
The slide 4 made to move is kept in continuous moving with even speed by the stepper motors 6X, 6Y for the in-plane displacement. During the displacement of the slide 4, the numbers of steppings effected by the stepper motors 6X, 6Y along the X- and Y-directions, respectively, are perpetually recorded. When completing the pre-set numbers of steppings n_{X} and n_{Y} that are synchronized with the respective dimensions of the field of view of the detector 1 along the X- and Y-directions, the slide 4 arranged in the slide holder 3 will have been shifted by just one field of view within the XY-plane. Preferably, the values of n_{X} and n_{Y} correspond to the nominal stepping numbers of the respective stepper motors 6X, 6Y, however, this is not necessary. It should be here noted that knowing the numbers of steps currently completed and the in-plane dimensions of the field of view, the in-plane position of said slide 4 relative to the optical detector 1 can be determined in every instant unambiguously. When during stepping within the XY-plane one of the stepping numbers n_{X} and n_{Y} corresponding to a dimension of one field of view has been reached, a proper electrical control signal (a triggering) is sent to the light source 2 by the stepper motor 6X or 6Y (or rather the electronics thereof) that currently makes the slide 4 to move along either the X- or Y-direction. Upon response to this triggering, to perform an exposition, said light source 2 illuminates at least that portion of the slide 4 which is just being digitized by high intensity light for a given period of time.
To find an ideal focal distance (that is, the sharpest/best image of the field-of-view sized slide region being just digitized), simultaneously with the in-plane displacement of the slide 4, said slide holder 3 is also displaced by the Z-direction stepper motor 6Z along the optical axis O. To record images in different focal planes, during the continuous displacement of the slide 4 along the Z-direction, said light source 2 is also made to operate at certain steppings of the stepper motor 6Z, and in every such instant an image of the slide region concerned is taken at the current focal distance. Thus, when focussing, several images of the slide region concerned are taken and the ideal focal plane is then determined on the basis of these images by applying the technique of interpolated focussing. To record the images belonging to the various focal distances, said light source 2 is made to operate in synchronous with the stepping effected by the stepper motor 6Z displacing along the Z-direction (preferably, per n_{Z} steps), in this variant of the digitizing method according to the invention via a trigger signal generated by the stepper motor 6Z. It is noted that due to the size of the field of view, the value of n_{Z} is much smaller than any of the values of n_{X} és n_{Y}.
The light emitted by the light source 2 operated in the above-discussed strictly timed manner, striking said slide 4, being scattered by it and then reaching the sensing surface 1a is detected by the optical detector 1, and the thus obtained piece of information, as the image of the slide region concerned, is transmitted to the control and processing unit 9 operating the apparatus 10 for further handling and/or processing according to needs.
In the meantime, said slide 4 is advanced into a position suitable for imaging the next field-of-view sized region thereof through the continuous shift of said slide 4 by the in-plane stepper motors 6X, 6Y. Then, repeating the above described steps, the digitization of said next region of the slide 4 is performed. It should be here noted that when a given field-of-view sized slide region is digitized, the displacement along the Z-direction for focussing purposes is commenced from that position of the slide holder 3 which it occupied when the previous field-of-view sized slide region was digitized (that is, after the n_{X}-th or n_{Y}-th stepping in the XY-plane).

Performing the above method, a digital image of every field-of-view sized region of the slide 4 that was earlier selected for digitization will be available, and by a per se known stitching procedure a montage image of the slide 4, that is a virtual slide is obtained. As it was mentioned earlier, the fields of view to be digitized are selected preferably on the basis of the preview image in a per se known manner. Naturally, a digital image of an arbitrary sized portion of the slide 4 can be produced by the method according to the invention.

According to a possible further variant of the inventive method, the trigger signals actuating the light source 2 can also be generated by the central control and processing unit 9 instead of the stepper motors 6X, 6Y, 6Z. In this case said central control and processing unit 9, additionally to triggering the individual steppings performed by the stepper motors 6X, 6Y, 6Z continuously, also transmits the appropriate trigger signal to the light source 2 when the pre-set stepping numbers fixed in harmony with the in-plane dimensions of the field of view used for the imaging are reached (that is, per every n_{X} or n_{Y} pieces of steps), and/or simultaneously with the completion of the prescribed (n_{Z} pieces of) steps for focussing along the Z-direction.

According to a possible yet further variant of the inventive method, instead of the light source operating with a single luminous flux, such a light source is applied for the digitization that is suitable for illuminating the slide 4 at a variable luminous flux. Accordingly, after completing the optional positioning of the slide holder 3 (and, hence, of the slide 4 arranged therein), a trigger signal is generated and then transmitted to the light source 2 by the central control and processing unit 9 simultaneously with making said slide holder 3 to move by the stepper motors 6X, 6Y, 6Z. Upon this triggering, said light source 2 starts to continuously emit light at a first luminous flux. Then, upon a trigger signal generated by either the stepper motors 6X, 6Y, 6Z or the central control and processing unit 9 in synchronous with the in-plane dimensions of the field of view used for the imaging and the Z-direction stepping within the course of the above detailed method, said light source 2 will operate at a second luminous flux that is much higher than the first one for a period of time—pre-set to be about 1 μs—of the exposition. Preferentially, said second luminous flux is set to be at least five times as high as the first luminous flux. To capture an image of proper contrast/sharpness, preferably the second luminous flux is chosen to be at least about 40 mJ per exposition.

It makes the assessment of virtual slides much easier if they are of about equal brightness/saturation. The emitted luminous flux of the light source 2 varies with time depending on aging of said light source 2. Consequently, the brightness/saturation of the virtual slides recorded with actively using said light source 2 will change from slide to slide as the age of said apparatus 10 increases. To avoid this, in a possible yet further variant of the method according to the invention, preferably before commencing the digitization of each of the slides a luminous flux balance measurement and then, depending on the result of said measurement, during the digitization, a luminous flux compensation is performed.

It is a generally accepted experience that a digital image comprised of pixels can be considered as image of proper saturation if about 60% of the pixels in said image have got a value of about 245 on a scale of saturation ranging from 0 to 255. Accordingly, during slide digitization it is attempted to satisfy this experimental requirement as much as possible for the virtual slides produced. To this end, the amount of light striking the slide 4 emitted by the light source 2 is modified according to needs by means of a mechanical member of a suitable design. In an embodiment, said mechanical member is provided by a member that can be introduced into the light path between said slide 4 and said light source 2, wherein said member is constructed with a plurality of portions with percentage light transmittivities differing from one another. The mechanical member is arranged, removably, in the light path in such a way that the light of said light source 2 fall on that portion of said member, which induces pictorial information of desired saturation on the sensing surface 1a of the optical detector 1. To this end, said mechanical member is subjected to calibration before the start of the digitization. In said calibration, it is systematically determined through the portion of what transmittivity value the light should be transmitted in order to achieve images of given saturation values when the light source 2 concerned is used. As a result of calibration, the transmittivity (in percentage values) of said mechanical light intensity control member will range between given lower and upper limits (e.g. from 10% to 100%) and preferably vary from portion to portion gradually, optionally equidistantly.

Said mechanical member can also be arranged between the slide 4 and the optical detector 1. In a preferred embodiment, said mechanical member is provided by a circular disk, wherein the portions of different transmittivities are formed by sectors of central angles of equal size m (for the sake of simplicity, m being an integer number, however, this is not a requisite) that are adjoined together in pairs along their legs. In such a geometrical construction, the number of sectors equals to 360°/m, that is, the number of sectors constituting the disk is e.g. 36, 18, 12, 8, etc. if said central angle is chosen to be m=10°, 20°, 30°, 45°, etc., respectively. In a possible further embodiment, said mechanical member is provided by a rectangular element, wherein the portions of different transmittivities are formed by regions that are aligned by one of their side-edges along one of the sides of said rectangular element and adjoined together in pairs along their other side-edges. Naturally, to modify the luminous flux of the light source 2, a mechanical member of any further suitable geometrical constructions can equally be applied.

Said mechanical light intensity control member, and/or its required portion is introduced into the light path by means of further stepper motor(s) and appropriate transmission(s), provided with this purpose only, upon an appropriate signal generated e.g. by the central control and processing unit 9 depending on the result of the luminous flux measurement performed with the light source 2 (with the presence no slide) before digitizing the next slide. When completing the digitization of the slide concerned, the removal of said mechanical light intensity control member from the light path or the change of its portion that had been used is also performed by means of said stepper motor(s) and transmission(s) upon the appropriate signal generated e.g. by the central control and processing unit 9.

Through the application of this latter variant of the method according to the invention, virtual slides of about identical brightness/saturation can be produced by the system forming the automated digitizing apparatus at any time, and independent of the wear-out of the light source to be used. Furthermore, when the images are captured, light intensities can always be kept below the sensing threshold of the optical detector, that is, the virtual slides will never go into saturation, not even accidentally, and thus a need for repeating the digitization of slides can be eliminated.

In practice, one of the in-plane dimensions (e.g. along the X-direction) of the surface of a slide to be digitized corresponds to the length of about a thousand field-of-view sized regions. According to our studies, the inventive technique enables digitizing an area corresponding to about thirty consecutive fields of view per second. Furthermore, the digitization takes place, particularly, in such a manner that upon a trigger signal of e.g. one of the stepper motors, the high intensity light source starts to operate and illuminates for about a time period of 1 μs. Preferably, the exposition itself also takes about 1 μs, but at most several μs's. It should be here noted that, according to our experience, due to an illumination of very short length, but of high intensity, a sharp image with good contrast arises, although, the exposition time of the optical detector is longer than the length of illumination by the high intensity light mentioned. The time remaining between two consecutive steppings is used to handle/process the data of the detector by the control and processing unit. It is obvious that the speed of digitization expressed in units of field-of-view/sec depends basically on the performance of the control and processing unit. Taking the above into consideration, a digitization speed of 100 to 120 field-of-view/sec can preferably be achieved by the present inventive digitizing method if proper signal processing throughput is provided.

A further advantage of the present invention besides its simplicity is that the slide displacing mechanism does not have to cyclically stop and restart for the digitization, and thus the time spent on digitization decreases to an enormous extent. In accordance with our studies, the time needed to digitize a sample/slide of ordinary size can be decreased by a factor of 3 to 5 (in particular, from about a minute and a half to about half a minute, twenty seconds) which means significant time saving in everyday clinical routine, where in certain cases several hundreds or even several thousands samples have to be digitized.

A yet further advantage is that the mechanical vibrations due to the start and the stop of the slide displacing mechanism are also eliminated. Moreover, the system according to the present invention is extremely compact, requires a small room, and due to expositions performed in synchronous with the operation of the stepper motors it works precisely and highly reliably. Furthermore, in this case no position detector is required either.

1. System for digitizing a moving slide comprising
a slide holder for receiving a slide and defining a plane of displacement;
stepper motors connected to the slide holder so as to induce a displacement with constant speed of said slide holder within the plane of displacement in first and second directions perpendicular to one another, as well as in a direction perpendicular to said plane of displacement;
a light source of high intensity arranged so as to expose at least a portion of the slide in a flashing manner as a response upon a trigger signal;
an imaging system designed for recording a digital image of the slide, said imaging system comprising an optical detector with a field of view having first and second in-plane dimensions, said detector facing the exposed portion of the slide; and
a control and processing unit connected to the stepper motors and the imaging system electrically, characterized in, that
said first and second dimensions of the field of view correspond to the shifts of the slide along the first and second directions, respectively, perpendicular to one another within the plane of displacement accomplished by the stepper motors via a set number of steppings in each direction, and
said trigger signal to activate said light source is generated and transmitted to said light source in synchronous with reaching at least one of the set stepping numbers for said stepper motors inducing a displacement of the slide in steps within the plane of displacement and cyclically as per the stepping numbers.

2. The system of claim 1, wherein each stepper motor inducing displacements of said slide in the plane of displacement is designed to be capable of generating a trigger signal activating said light source and is connected to said light source via a communication link that is apt for transmitting said trigger signal directly to said light source.

3. The system of claim 1, wherein the control and processing unit is designed to be capable of generating a trigger signal activating said light source and is connected to said light source via a communication link that is apt for transmitting said trigger signal directly to said light source.

4. The system of claim 2, wherein said communication link is provided by a wired or a wireless communication link.

5. The system according to claim 1, wherein the stepper motor inducing displacements of said slide in a direction perpendicular to the plane of displacement is designed to be capable of generating a trigger signal that activates said light source and is connected to said light source via a communication link that is apt for transmitting said trigger signal directly to said light source, and wherein the rate of generation of said trigger signal is determined by the stepping number set for the stepper motor inducing slide displacements along the direction perpendicular to the plane of displacement.

6. The system according to claim 1, wherein the light source comprises a light source of continuous emission with low luminous flux and a light source of pulsed emission with high luminous flux, wherein said trigger signal activating the light source activates the latter light source.

7. The system according to claim 1, further comprising a mechanical light intensity control member to adjust the percentage amount of incident light passing therethrough, said member is designed to be inserted into between the optical detector and the light source in the path of the light emitted by said light source temporarily.

8. The system of claim 7, wherein said mechanical light intensity control member comprises a plurality of portions of different percentage light transmittivity, wherein to set the luminous flux incident onto the optical detector, said portions, one at a time, can be inserted into the path of the light emitted by the light source in a controlled way.

9. Method of digitizing a moving slide, comprising
arranging a slide with a sample in a slide holder so as to face an optical detector with a field of view having first and second in-plane dimensions,
displacing said slide holder by stepper motors with constant speed along perpendicular directions within the plane of said slide, meanwhile exposing at least a portion of said slide with a high intensity light source,
sensing light from said exposed portion of the slide falling onto the optical detector and converting it into pictorial pieces of information characteristic of said portion of the slide, wherein said slide is divided into field-of-view sized regions and said pictorial pieces of information characteristic of the thus obtained regions are captured region by region,
choosing said first and second dimensions of the field of view so as to coincide with in-plane shifts of the slide along perpendicular directions accomplished by the stepper motors via a set number of steppings in each direction, and
activating said light source so as to expose said slide in synchronous with reaching at least one of the set stepping numbers for said stepper motors inducing in-plane displacements of the slide and cyclically as per said stepping numbers.

10. The method of claim 9, further comprising displacing the slide with constant speed along a direction perpendicular to the plane of said slide by a further stepper motor simultaneously with the in-plane displacement of the slide, meanwhile activating the light source in synchronous with reaching a set stepping number for this further stepper motor and cyclically as per said stepping number, whereby obtaining a plurality of images of said slide region at various focal planes and choosing as pictorial pieces of information characteristic of said region that image from the thus obtained ones which belongs to the ideal focal plane.

11. The method of claim 9, further comprising creating a virtual slide by means of stitching the pictorial pieces of information captured region by region of said slide without overlapping of said pieces.

12. The method according to claim 9, comprising shifting said light source from an operation mode of a first luminous flux into an operation mode of a second luminous flux via activating it, said second luminous flux being much higher than said first luminous flux.

13. The method according to claim 9, comprising inserting a mechanical light intensity control member between said light source and said optical detector in a controlled way so as to maintain the amount of light reaching said optical detector at a level to result in assessable pictorial pieces of information of said region of the slide.
